(19) United States
(12) Patent Application Publication
(10) Pub. No.: US 2005/0006286 A1
(43) Pub. Date: Jan. 13, 2005

(54) Method and device for processing mail

(76) Inventors: Peter Fery, Zwingenberg (DE); Jurgen Helmus, Bonn (DE); Gunther Meier, Reinheim (DE); Dieter Stumm, Grossefehn (DE); Carsten Vullriede, Hodenhagen (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/493,155

(22) PCT Filed: Oct. 15, 2002
(86) PCT No.: PCT/DE02/03888

(30) Foreign Application Priority Data
Oct. 16, 2001 (DE) 11101 50 455.1

(51) Int. Cl. B07C 5/00; G06G 7/00

(52) U.S. Cl. 209/584; 209/900; 705/400

(57) ABSTRACT

Disclosed herein are a method and device for processing mail. The method includes checking mail to determine if it has been franked, and if it has not been franked or the franking determined deviates from the franking required, producing and printing on the mail a fee control code. The method also includes sorting the mail according to the fee control code.

The invention relates to a method for processing mailpieces, whereby for individual mailpieces, address information is acquired about the specific recipient of the mailpiece, and whereby a coding is determined from the address information.

The invention also relates to a device that is suitable for the execution of the method.

A generic method is described in International Patent Application WO 98/17405.

With such methods, mailing addresses are preferably read automatically by means of optical character recognition (OCR). Such automatic reading with a subsequent determination of an address code and an imprint of this address code in the form of a barcode are implemented by the applicant on an industrial scale.

Moreover, it is known that postal service providers check the correctness of the payment made for mailpieces.

The invention is based on the objective of using the simplest possible means in order to achieve the most reliable way to identify and divert suspicious mailpieces.

According to the invention, this objective is achieved in that a method of the generic type is carried out in such a way that a checking procedure ascertains whether the mailpiece has the expected postage and that, if the mailpiece does not have any postage or if the detected postage differs from the expected postage, a payment assurance code is generated, in that the payment assurance code is printed onto the mailpiece and in that, within the scope of a subsequent sorting procedure, the sorting is carried out as a function of the payment assurance code.

The invention combines the processing steps of sorting mailpieces and checking the correctness of the postage that has been applied onto them, whereby these steps had been separate from each other up until now, and carries out the sorting as a function of a payment checking procedure.

The printing of a payment assurance code allows mailpieces that involve the suspicion of forgery to be diverted out of the normal processing sequence for mailpieces that have the correct postage.

The payment assurance code is a marking containing information about a result of each checking procedure that has been carried out.

It is especially advantageous to separate mailpieces that have different payment assurance codes from each other within the scope of the sorting procedure.

It is especially advantageous to carry out the method or to equip a device for carrying out the method in such a way that the mailpieces having different payment assurance codes that have been separated from each other are sorted into different compartments.

It is also advantageous for the payment assurance code to be printed as an addition to the address code.

An embodiment of the method that can be effectuated especially simply in terms of process technology is carried out in that the payment assurance code is printed essentially in the same format as the address code and incorporated, for example, into the address code at certain places. A preferred example for places where the payment assurance code can be incorporated are positions T1/T2.

Through the above-mentioned embodiments, it is possible to integrate the address information as well as the payment assurance information into an imprint, for example, a barcode, that is applied onto the mailpiece.

In this manner, mailpieces for which a suspicion of fraud has not been confirmed—after a determination that no irregularities are present—can be returned to the normal processing sequence for the mailpieces without there being a need to once again detect the recipient address.

Another, likewise advantageous embodiment of the method is characterized in that, instead of the address code, the payment assurance code is applied onto the mailpiece. This variant of the method has the advantage that it prevents a suspicious mailpiece from nevertheless entering the normal processing sequence for mailpieces.

Another subject matter of the invention is to provide a device for processing mailpieces with an address reading machine, with a means for printing the mailpieces having an address code determined as a function of ascertained address information, and with a sorting machine for sorting the mailpieces as a function of the address code printed on them in such a way that said device has a means for detecting suspicion of forgery and for categorizing different suspicious cases, and that it has a control unit for the printing means, whereby the control unit is configured in such a way that it can control the printing of the payment assurance code onto the mailpiece.

This device is suited for the execution of all possible process steps.

Additional advantages, special features and practical refinements of the invention ensue from the subclaims and from the following presentation of preferred embodiments of the invention.

Below, the invention will be presented with reference to the processing of mailpieces in consecutively arranged machines. However, other devices, for example, one for reading the addresses and one for sorting the mailpieces, are also suitable for the execution of the method.

An especially preferred embodiment is depicted below with consecutively arranged machines in which the detection of the recipient address and of the payment assurance, as well as the sorting of the mailpieces are performed especially quickly and reliably by an address reading machine and a sorting machine.

Whenever possible, it is especially advantageous to combine the functions of generating the address code and of checking the authenticity.

In particular, mailpieces that do not have one or more expected security features are diverted from the production sequence, that is to say, from the normal conveying sequence for the mailpieces.

An example of such a security feature is the presence of superfluorescence. Fundamentally, conventional fluorescence is also suitable as a means for checking the authenticity. So-called superfluorescence, which is based on an evaluation of the generally much weaker anti-Stokes lines, however, is an especially suitable security feature.

For example, after a preceding irradiation with infrared light, it is checked whether an emission of visible light occurs. As an alterative, for example, after an irradiation with visible light, it is checked whether an emission occurs in the spectrum of UV light. Advantageously, here a spectral distribution of the light emitted from the area of the mailpiece is examined and/or it is checked whether said spectral distribution contains spectral fractions of a previously defined wavelength and intensity.

Since substances, especially substances with constituents of rare-earth atoms having one or more discrete fluorescence lines, are used for the production of forgery-proof superfluorescence dye, it is possible to recognize whether a true superfluorescence dye is present.

The depicted means for checking security features can be replaced by means that have the same effect.

If such a security feature or another possible security feature such as the presence of a cryptostring that has been digitally encrypted and that has to be decrypted is not present, then the mailpiece is provided with a coding. Preferably, this coding is integrated into the address code so that the mailpiece can pass through the normal conveying sequence until it is diverted and thus can be diverted without any further effort. The already described integration of the payment assurance code into the positions T1/T2 of the address code is especially suited for this purpose.

It is also advantageous to create possibilities at suitable places in the device for diverting mailpieces on which one or more of the security features are not found and/or which do not contain a prescribed graphic symbol for franking.

Each mailpiece that runs through an address reading machine is coded so that it can be further processed in the fine sorting machine located downstream.

So far, the 11-digit address code contains only the address for the mailpiece. With the introduction of the Additional Information about Mailpieces (AIM) project, a mailpiece that is “negatively conspicuous” in the address reading machine (e.g. in the case of a sender-franked mailpiece, the identification cannot be read) receives a so-called payment assurance coding (=payment assurance warning).

This coding is applied, for example, at the positions “T1/T2” (technical term in coding technology) of the normal address code, as a result of which it is then 13 characters long. On the basis of the code print-out, the mailpiece can be diverted in the fine sorting machine into the appropriate payment assurance compartment.

As a matter of principle, any payment assurance codes can be used. However, it has been found that the use of 2-digit payment assurance codes is suitable to detect many, or even all, interesting payment assurance events and to integrate them into the further processing of the mailpieces, especially their sorting. Moreover, such a 2-digit payment assurance code can be integrated especially easily into the address code.

The invention, however, is not limited in any way to such an address code. For example, in an especially simple case, a 1-bit code can be used. In the example using a 1-bit code, a distinction is only made between mailpieces that involve the suspicion of fraud and mailpieces that do not involve the suspicion of fraud. Such a distinction is an especially simple implementation of the invention.

Conversely, however, it is likewise possible to integrate considerably more complex payment assurance codes, for example, in order to subject different positive or negative lists with special suspicious cases to a separate processing and systematic diverting at selected places in the processing sequence/./operation.

Therefore, the size of the payment assurance code is not limited but rather can be adapted to the particular operational requirements of a postal service provider that is making use of such a code.

The following presentation of payment assurance codes is only intended as a possible example of an integration of a payment assurance code into the process sequence within the scope of automated processing of a large number of mailpieces in an automated large-scale operation and consequently, it is only meant by way of an example.

The decision-making table specifies which payment assurance codes are applied onto the mailpieces as a function of the checking procedures to be carried out. The codes result in the mailpieces being diverted into specified payment assurance compartments.

| | | | | Payment | | |
|---|---|---|---|---|---|---|
| | | | Further | assurance | Payment assurance | |
| No. | Checking procedures | Decision | processing | coding | compartment | Priority |
| 1. | Identify the type of postage | | | | | |
| 1.1 | Sender franking imprint | Y | See Point 2 | | | |
| | recognized (SFM = sender | | | | | |
| | franking machine) | | | | | |
| | | N | See Point 1.2 | | | |
| 1.2 | Image of a PC-franking | Y | See Point 3 | | | |
| | (PC-F) recognized | | | | | |
| | | N | See Point 4 | | | |
| 2. | Is SFM identification (I) | I/F | | | | |
| | and franking value (F) | | | | | |
| | completely readable? | | | | | |
| | (parallel examination) | | | | | |
| | | Y/Y | See Point 2.1 | | | |
| | | Y/N | Divert | 01 | SFM franking not | 2 |
| | | | mailpiece | | readable | |
| | | N/Y | Divert | 02 | SFM identification not | 1 |
| | | | mailpiece | | readable | |
| | | N/N | Divert | 03 | SFM identification not | 0 |
| | | | mailpiece | | readable | |
| 2.1 | Is the read-in SFM | Y | Divert | 04 | SFM negative file | 3 |
| | identification in the | | mailpiece | | | |
| | negative file? | | | | | |
| | | N | See Point 2.2 | | | |
| 2.2 | Is the read-in SFM | Y | See Point 2.3 | | | |
| | identification in the | | | | | |
| | positive file? | | | | | |
| | | N | Divert | 05 | SFM not in positive | 4 |
| | | | mailpiece | | file | |
| 2.3 | Is minimum postage | Y | See Point 4 | | | |
| | requirement met for SFM? | | | | | |
| | | N | Divert | 06 | SFM insufficient | 5 |
| | | | mailpiece | | postage | |
| 3. | 2D barcode readable? | Y | See Point 3.1 | | | |
| | | N | Divert | 11 | PC-F negative file/ | 0 |
| | | | mailpiece | | barcode not readable | |
| 3.1 | Decrypt cryptostring | Y | See Point 3.2 | | | |
| | | N | See Point 3.3 | | | |
| 3.2 | PC-F version OK? | N | Divert | 22 | PC-F version/date/ | 1 |
| | | | mailpiece | | insufficient postage | |
| 3.3 | Postage ID valid? | N | Divert | 12 | PC-F suspicion of | 2 |
| | | | mailpiece | | forgery | |
| 3.4 | License number in negative | Y | Divert | 13 | PC-F negative file/ | 3 |
| | file? | | mailpiece | | barcode not readable | |
| 3.5 | Hash value OK? | N | Divert | 14 | PC-F suspicion of | 4 |
| | | | mailpiece | | forgery | |
| 3.6 | Date OK? | N | Divert | 21 | PC-F version/date/ | 5 |
| | | | mailpiece | | insufficient postage | |
| 3.7 | Minimum postage | N | Divert | 23 | PC-F version/date/ | 6 |
| | requirement met? | | mailpiece | | insufficient postage | |
| | | Y | Normal | 00 | | |
| | | | conveyance | | | |
| 4. | No payment assurance | | Normal | 00 | | |
| | coding | | conveyance | | | |

0 = max

1. A method for processing mailpieces, the method comprising the steps of:
(a) acquiring address information about a specific recipient of a mailpiece from the mailpieces;
(b) generating an address code from the address information;
(c) ascertaining with a checking procedure whether the mailpieces have the expected postage;
(d) generating a Payment assurance code if the mailpieces do not have any postage or if the detected postage differs from the expected postage;
(e) printing the payment assurance code onto the mailpiece ; and
(f) subsequently carrying out a sorting procedure as a function of the payment assurance code.

2. The method of claim 1, wherein the printing step further comprises printing the payment assurance code as well as the address code are printed on the mailpieces.

3. The method of claim 2, wherein the printing step further comprises printing the payment assurance code as an addition to the address code.

4. The method of claim 3, wherein the printing step further comprises printing the payment assurance code at places on the mailpiece that are intended for the address code.

5. (Canceled).

6. The method of claim 1, wherein the sorting procedure further comprises separating mailpieces that have different payment assurance codes from each other.

7. The method of claim 6, wherein the sorting procedure further comprises sorting the mailpieces having different payment assurance codes that have been separated from each other are sorted into different compartments.

8. A device for processing mailpieces, the device comprising:
(a) a Printer capable of printing on the mailpieces with an address code determined as a function of ascertained address information;
(b) a sorting machine for sorting the mailpieces as a function of the address code printed on them;
(c) a device capable of detecting the type of postage and the suspicion of fraud and capable of categorizing different suspicious cases; and,
(d) a control unit for the printer, wherein the control unit is capable of controlling the printing of the a payment assurance code on the mailpiece.
